(19) United States
(12) Patent Application Publication
(10) Pub. No.: US 2017/0011077 A1
(43) Pub. Date: Jan. 12, 2017

(54) SCALABLE ANNOTATION ARCHITECTURE

(71) Applicant: Socrata, Inc., Seattle, WA (US)

(72) Inventors: Theodore Nicholas Kypreos, Bellevue, WA (US); Jason Kroll, Seattle, WA (US); Marc Szeto-Millstone, Seattle, WA (US); Navdeep Singh Dhillon, Seattle, WA (US); Ayn Leslie-Cook, Lynnwood, WA (US)

(21) Appl. No.: 15/204,821

(22) Filed: Jul. 7, 2016

Related U.S. Application Data
(60) Provisional application No. 62/189,656, filed on Jul. 7, 2015.

(51) Int. Cl. G06F 17/30; G06Q 40/00

(52) U.S. Cl. CPC G06F 17/30306; G06F 17/30997; G06Q 40/00

(57) ABSTRACT

Methods, systems, and techniques for annotating large amounts of data are provided. Example embodiments provide a Scalable Annotation Architecture (a “SAS”), which builds predictive models for an annotation from the ground up, without knowledge of the data. The SAS operates by performing in an iterative fashion a process that seeds training data and hypothesizes a predictive model based upon that data, then sends samples of the data to a crowdsourcing environment to provide selective verification. This process is repeated iteratively until a desired precision is reached and then the model is employed independently in a production system. In one embodiment, the SAS is used to annotate data provided by an open data platform.

### CROSS-REFERENCE TO RELATED APPLICATIONS

This application claims the benefit of U.S. Provisional Patent Application No. 62/189,656, entitled “SCALABLE ANNOTATION ARCHITECTURE,” filed Jul. 7, 2015, which is incorporated herein by reference in its entirety.

### TECHNICAL FIELD

The present disclosure relates to methods, techniques, and systems for annotation of data and, in particular, to methods, techniques, and systems for automatically annotating open data and generating a taxonomy for a set of datasets.

### BACKGROUND

The word “taxonomy” has been traditionally associated with the classification of living organisms into different scientific classifications; however, in recent times, it has also been applied to the general process of sorting, classifying, or categorizing “things” into groups. Thus, other schemes of classification for things such as genomes, smells, computer systems, websites, political identities, and the like, have been developed over time. Taxonomies are typically formulated by brute force (by hand) and a priori, before reviewing the data that is to be classified. Thus a taxonomy may organize data displayed on a website for example, by categorizing the data of a website into groups.

As new types and sources of data become available, it becomes increasingly important to development mechanisms that aid in characterizing that data automatically if not semi-automatically. Proper characterizations allow end-users to browse the data and discover information rather than search based upon known keywords.

### BRIEF DESCRIPTION OF THE DRAWINGS

FIG. 1 is a block diagram of the process used by a Scalable Annotation System for creating a predictive model for a particular annotation.

FIG. 2 is an example screen display of an example survey for use with a crowdsourcing venue.

FIG. 3 is an example block diagram of a portion of a keyword graph that can be used by an automated tool for selecting training dataset examples.

FIG. 4 is an example graph of the results of survey questions to answer whether the annotation “animal” is appropriate for the dataset(s) being surveyed.

FIG. 5 is an example block diagram of components of an example Scalable Annotation Architecture.

FIG. 6 is an example block diagram of an example computing system that may be used to practice embodiments of a SAS described herein.

### DETAILED DESCRIPTION

Embodiments described herein are directed to tools that facilitate the use and sharing of “open data.” Open data as used herein refers to any data that anyone is free to use, reuse, and redistribute—subject at most to a requirement to attribute and share-alike (share the results of open data mixed with other data). This data is typically supplied as a “dataset,” which refers to the metadata that describes the information in the dataset as well as the data itself. The data may be arbitrary but is typically provided in binary code or a human-readable text file with a pre-defined format.

In particular, the environment or platform referred to herein allows end-users to browse open data via two major approaches: the curated, top-down approach and the bottom-up, organic search approach. The bottom-up, organic search approach operates using keywords to locate relevant datasets and is not discussed further herein. The curated, or semi-curated top-down approach encourages and facilitates the generation of computer driven tools that can guide end-users interested in browsing or pursuing specific topics or classifications. End-users using the curated or semi-curated approach may or may not know in advance what they are looking for—hence they may not be able to use a bottom-up approach that uses keywords the end-user is presumed to be aware of.

The topics/classifications used by the top-down approach may take the form of “annotations” (tags, concept associations, topic associations, classifications, and the like) associated with particular datasets. For example, a dataset may or may not be about “animals” or about “crime.” A dataset may be annotated, for example, by associating a tag representing the topic/classification with the metadata of the dataset, or by otherwise associating the tag with the dataset such as through an external mechanism such as a data repository that indexes datasets and their annotations (and potentially other useful information).

In order for the curated approach to operate meaningfully and effectively, each dataset needs to be tagged with the annotations that describe the data. However, there is no known taxonomy (e.g., categorization, grouping, classification, or the like) for describing datasets (of potentially arbitrary data) comparable to the biological classifications of living organisms such as plants. Moreover, definitions of categories/taxonomies of data may change as content from different sources with different underlying definitions and structure is incorporated into a corpus of data over time. For example, a “crime” from a police department that is part of the governance of a state may have different meaning (e.g., set by statute) than a “crime” from a neighborhood community center (which may have a broader view of what constitutes a crime, for example).

In addition, a publisher that provides data to the platform (herein referred to as a data publisher or content publisher) may define internally what their data and initially provided annotations mean, typically by providing metadata or information with the data that describes the data such as a “name” and “description.” Even so, customers of the data (end-users) may not ascribe the same definitions to these annotations or data descriptions. Opening up data (for use as “open data”) means that the top-down approach has to be disentangled from the content publishers (and content creators, if different) to solve the overall problem of providing meaningful global annotations for the search and discovery of content by the end-user.

Accordingly, in order to provide global annotations that are resilient for all or most datasets and that expand over time to fit new datasets as the system grows (with potentially a limitless number of datasets), it becomes desirable to provide an architecture for discovering annotations, building predictive models that can be used to automatically apply these annotations to datasets (new or old) with a desired level of precision, and scaling out the models as new models are developed and new annotations are added to the system.

Embodiments described herein provide enhanced computer- and network-based methods, techniques, and systems for providing a scalable architecture to annotate datasets. Example embodiments provide a Scalable Annotation System (“SAS”), which enables data platforms, for example, open data platforms (and other environments) to generate (e.g., develop, create, design, or the like) predictive models for annotating data in a cost efficient manner using an iterative process. The iterative process makes an educated “guess” on training data for a model for an annotation (e.g., a tag, topic, classification, grouping, etc.) and improves that model over time (over multiple iterations) to a tunable precision by sending select subsets of the data to one or more crowdsourcing venues (or human labeling by other means) for verification. This process is repeated in a “feedback” loop until the desired precision of the training/test data for the model is reached. For example, a model for the annotation “animal” is going to have a set of discriminating words, phrases, or descriptors (features) that, if present in the dataset, are likely to indicate that the dataset is about an animal and if not present in the dataset are likely to indicate that the dataset is not about an animal. The model is then used to annotate all of the datasets. In one embodiment of the SAS, the generated predictive models are Support Vector Machines, which are non-probabilistic binary classifiers. However, other machine learning techniques may be similarly incorporated or substituted such as, but not limited to, naïve Bayesian networks, neural networks, decision trees, and the like.

One of the advantages of SAS is that each derived model is independent. Thus, it is possible to create and apply more than one model per annotation, and different models for different annotations, and apply them to the datasets without concern for the models interfering with each other. In addition, models that are not performing well may be tossed out without breaking the system and new models, for example for new annotations, added at any time. This provides a degree of scalability to the system as the datasets grow over time and a taxonomy of possible annotations is developed.

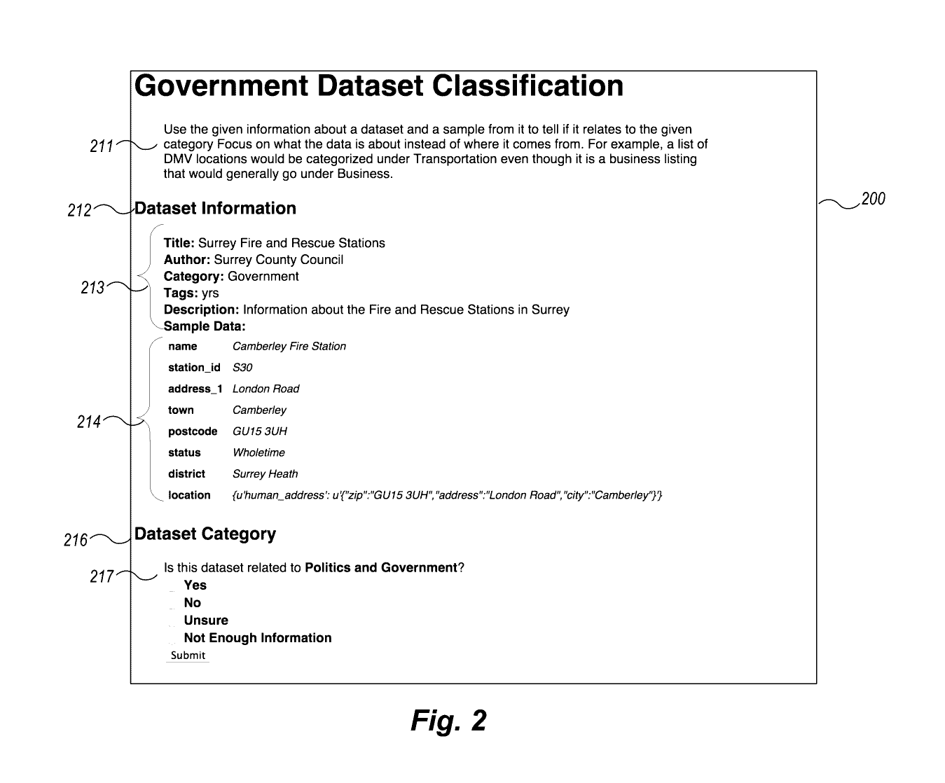

As mentioned, during the feedback loop used to create a model for an annotation, a subset of the datasets (a subset of test/training data) is send to a crowdsourcing venue for verification and to improve the accuracy of the training data. Here a crowdsourcing venue refers to any organization, institution, application, or API that supports the performance of (typically small) divided tasks to be performed by humans via, for example, an open call or invitation for work. For example, crowdsourcing has been used to identify and group images or to look for a particular image (e.g., a needle in hay stack problem). AMAZON MECHANICAL TURK is one example of such a program, although others may be incorporated. In the case of SAS, the crowdsourcing venue is sent a “survey” (e.g., questionnaire, work request) of one or more questions to be answered for one or more datasets, where each question refers to a (row of a) dataset and the dataset's metadata and requests the recipient to indicate whether the annotation describes that data. For example, the survey may ask a question such as: is this (row of the) dataset (and metadata presented) about animals? Surveys are described further below with reference to FIG. 2. When using the crowdsourcing venue, the SAS indicates that it wants the survey to be completed by “n” number of recipients. If the statistical confidence in the results doesn't indicate a desired value (e.g., less than y% of the survey responses showed the surveyed dataset to be positive examples of the surveyed annotation—not enough positive examples), then the survey (or some portion of it) may be requested from an additional “m” number of recipients. In this way crowdsourcing may be used for human verification without the expense of verifying the entire corpus of data.

Several non-trivial issues confront the SAS in the development of predictive models for annotating the datasets: namely,

1. No training data exists a priori for a given annotation so this initial data must be developed;

2. The set of annotations is unknown and may (likely) evolve over time; and

3. Money is a finite resource.

If the third premise were not true, then arguably every dataset could be sent en masse to a crowdsourcing venue and individually annotated by humans. However, as explained further below, using crowdsourcing (or other human labeling means) to hand label all datasets for a platform would be cost prohibitive for most platforms including the SAS.

Thus, to address these issues, the SAS combines a process of initially creating training data using a seeding algorithm and creates an initial “ansatz” (“guess”) predictive model which is augmented over time using subsets of human verified data to generate better accuracy.

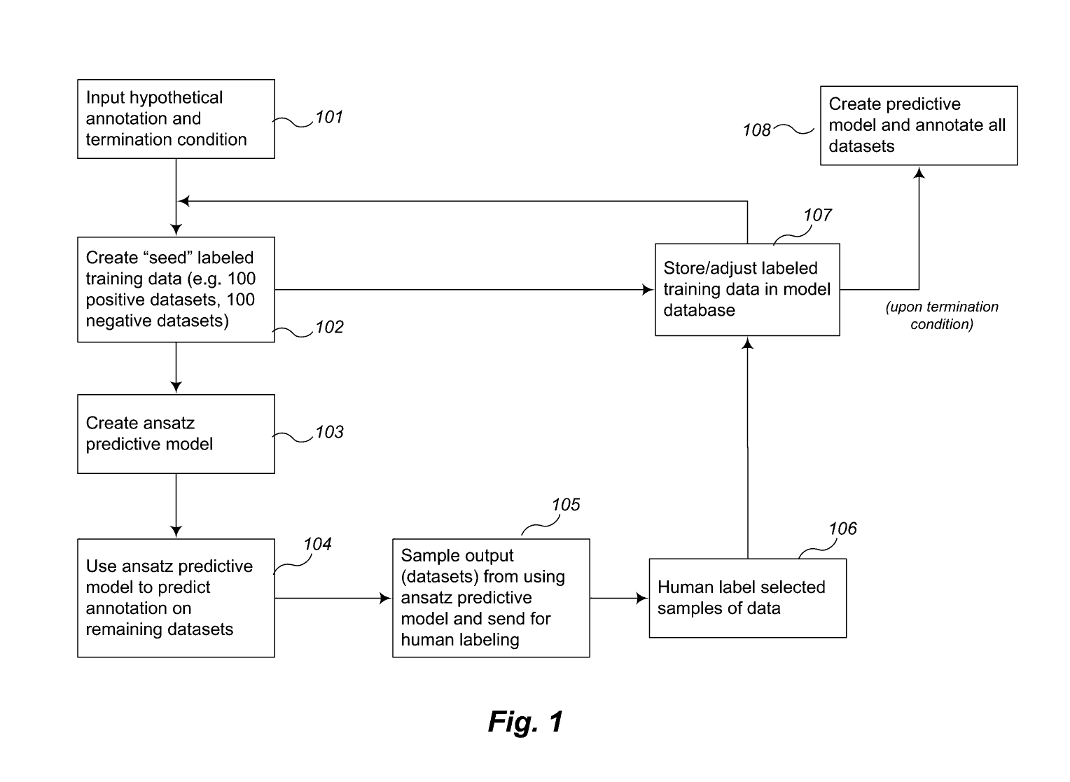

FIG. 1 is a block diagram of the process used by a Scalable Annotation System for creating a predictive model for a particular annotation. The diagram illustrates the iterative/feedback loop to improve the training sets for an annotation using a combination of seed generation and human labeled datasets until an indicated level of precision or other termination condition (such as reaching a maximum cost) is reached. The entire process is run by computer logic (an annotations training data collection system) that controls the SAS to automatically generate the desired predictive model. The annotations training data collection system (“ATDCS”) is primarily run by computer with the ability for the human operator to interrupt or set operating conditions for the logic. In some embodiments, the ATDCS is entirely automated.

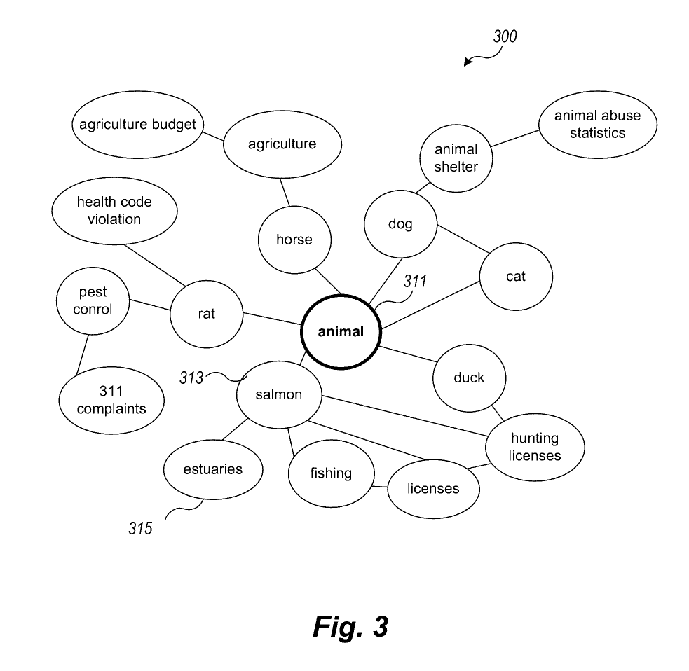

In particular, in block 101, a desired annotation is input into the system (e.g. “animal”) and an indication of a termination condition is expressed. For example, a termination condition may be expressed as the number of desired positive and negative dataset examples (of the annotation), a desired or maximum budget to spend on crowdsourcing augmentation, some mixture of both, or some other termination condition. Blocks 102 through 107 are then repeated iteratively to collect/create test (positive and/or negative) datasets for the model until this termination condition is reached. Specifically, block 102 uses a seed word or phrase, which is presumed to be predictive of the annotation, to create training data with a certain (settable) number of positive examples and negative examples. Typically, this seed word or phrase is a keyword known to result in a positive result. For example, if the desired annotation is “animal,” then the datasets are initially searched for a seed word such as “dog,” “cat,” or “animal shelter.” In some example ATDCS systems, the initial keywords are human provided (socially provided) tags; in other examples, the initial keyword is machine provided. If the seed word/phrase is found, then the dataset is deemed a positive dataset. If the seed word is not found and insufficient positive datasets have been located in this seed round, then the logic endeavors to find other keywords that result in positive dataset examples. (For example, using keywords immediately connected to the current keyword in a taxonomy of keywords known thus far to the system.) At some point, the logic determines a set of keywords that can be used to determine negative examples as well. Examples of specific logic for making these determinations are described with reference to FIG. 3.

The seed labeled datasets are stored by logic 107 in a data repository for storing the training dataset information, such as a model database (database containing information useful to the models being built by the system). In block 103, the logic creates an (initial) ansatz model using the current training dataset information and in block 104 uses this ansatz model to predict whether the annotation applies to all of the remaining datasets. (This information results can also be stored in the model database.) Recall that the ansatz model, in one embodiment, is also an SVM (Support Vector Model) which can classify all of the remaining datasets even though it truly is a “guess”—some results will be correct and others not. These processes are described further below in the “Ansatz/Seed Model” section. Block 105 samples output (some datasets) from those annotated by the ansatz model and send representations of these datasets off (as surveys) in block 106 to be hand labeled, such as by a crowdsourcing venue or other hand labeling process. The sampling process and crowdsourcing survey process is described further below in the “CrowdSourcing” section. The results of the human labeled data are stored by logic 107 in the data repository for storing the training dataset information (e.g., the model database). Specifically, in one example SAS, the human labeled data stored by logic 107 are “preferred” over the seeded results and thus supplemented by data derived from the ansatz model to reach the desired number of positive and negative examples.

Then, either the logic returns to the beginning of the loop in block 102 if the termination condition is not yet met (e.g. not enough positive and/or negative dataset examples with sufficient precision), otherwise then in block 108, the stored and labeled training datasets are used to construct a predictive model for a particular annotation, which is used to annotate all of the datasets in the corpus. More specifically, feature extraction is applied to each remaining dataset and the constructed predictive model is applied to the extracted features of each remaining dataset to determine whether that particular remaining dataset should be annotated with the particular annotation that is the subject of the constructed model.

In one example SAS, annotating a dataset may comprise associating an annotation, for example a word or phrase tag, with the metadata for a dataset in a data repository. Other example SASes may comprise other methods for annotating the dataset. For example, an index may be created that cross references annotations to dataset descriptors. Annotations are typically in the form of words or phrases and may also contain any alpha numeric sequence. Also, other forms of annotations may be contemplated, such as annotations that contain audio, video, or static image data instead of or in addition to words or phrase tags. Other implementations are similarly contemplated.

The logic of the annotations training data collection system (ATDCS) of the SAS is also shown as pseudo-code in Table 1 below. This logic is similar to the logic described with reference to FIG. 1.

TABLE 1
Algorithm 1 High-level pseudo-code description of the algorithm.

Input: annotation(s)
Input: terminating conditions
while (terminating condition is FALSE) do

collect test/train data from database
build new model
(prediction results) ← predict on rest of metadata
(annotation surveys for crowdsourcing) ← sample from (prediction
results) for

crowdsourcing

```
for all annotation surveys do
  execute survey
  update database
end for
check terminating conditions
```

end while

### Cost Considerations

For most platforms, cost is a big issue. Therefore, it is desirable to automate some process for finding training data because it is not practical or possible to have humans hand annotate every dataset—it is too costly and time consuming. When a dataset is loaded into the platform, there is typically some, but not necessarily a lot of, metadata used to describe the individual dataset and the metadata may be severely incomplete or “incorrect” from a global (across all datasets) perspective. The types of datasets that are loaded also may lend themselves to many different topics/categories and potential annotations. Thus, it becomes imperative to allocate money wisely when the number of datasets reaches the tens of thousands with potentially hundreds (or more) of annotations.

Industrial jargon generally evolves and as does the dataset content over the number and types of datasets available on the platform and hence what different annotations mean. There may not be initially enough information to annotate all datasets (e.g., some categories do not apply to the all of the datasets and some datasets may not yet be associated with categories that have been “discovered” as part of the taxonomy being developed). Still, enough features and predictive model(s) need to be made available in order to automatically suggest annotations when confronted with a new dataset.

Hypothetically, the simplest path for the SAS to gather data to train a new model would be to send all (or some large random sample) of the metadata to a crowdsourcing venue. However, to send all of the datasets to the crowdsourcing venue would be cost prohibitive for most platforms, as shall be seen from the computations below.

For simplicity of example, assume that a survey (for a single dataset) has one question, that is, whether a particular annotation applies, and that this question can be answered by “yes,” “no,” “unsure.” In this example, each question applies to a single annotation—thus there is a survey per annotation per dataset.

FIG. 2 is an example screen display of an example survey for use with an example crowdsourcing venue. This survey 200 may be machine generated, for example, by one of several templates available with the system. In example survey 210, only one dataset, represented by dataset information 212, is the subject of the questions 217 posed to the user. In particular, the user is given information about the dataset from the dataset metadata reflected in metadata fields 213 and the column names and their respective values for at least one row of actual data in the dataset shown as data fields 214, and is asked in questions 217 whether the dataset relates (in this particular example survey) to the annotation “Politics and Government.” The user must chose a user interface control (e.g. a radio button or other field) corresponding to “yes,” “no,” “unsure,” or “not enough information.” Many other surveys are possible, including those generated from templates, including ones with multiple annotation questions per dataset, different questions per dataset, and with other layouts.

Further suppose that the SAS desires 100 datasets as positive training examples and 100 datasets as negative training examples for a model for the annotation “animal.” Also assume for the sake of discussion that it may take at least 500 surveys (using the assignment of 1 annotation per dataset in a survey) to find the needed training examples as long as there are not a lot of “unsure” answers selected. Assume that 7 people respond to take these (500) surveys and that the cost from a crowdsourcing venue is $0.025 per survey. The cost of obtaining training data for a single model for a single annotation can then be expressed as:

Cost for training data=# people responding*# surveys*cost per survey (1)

or 7*500*0.025=$87.5 per model (per iteration). Based upon average statistics of running the SAS over a period of time, a minimum of 7 people is typically needed (to determine a yes/no answer) with an average of 10-18 people—or $125-$225 per iteration for building a model for a single annotation. If it takes 10,000 iterations to collect training data for 1000 annotations, the cost balloons to 90,000 for 18 people.

Now suppose instead that it takes 10,000 datasets (e.g. all of the datasets are sent to the crowdsourcing venue) to obtain training data (positive and negative examples) for a model to assign the single category “Politics and Government” to a dataset, then the cost balloons to 10,000*0.025*18=$4,500 per annotation. If the system is assigning 1000 annotations (10,000 datasets*1000 annotations), the cost balloons to 4,500,000. Thus, it is clearly more cost effective to limit the number of surveys to be sent to a crowdsourcing venue rather than have the crowd evaluate each annotation for each dataset.

Some control of cost can be obtained as well by including the assignment of more than one annotation in a single survey.

### Ansatz/Seed Model

As described above with respect to FIG. 1, the annotations training data collection system (ATDCS) that controls the SAS to automatically generate a desired predictive model and initially annotate all data sets first seeds the entire process with at least one word or phrase (one or more feature(s)) likely to be present when the annotation is a valid descriptor/tag for the dataset. For example, when the annotation is “animal,” it is likely (in some number of cases) that the word “dog,” “cat,” or “animal shelter” (some keyword) is present somewhere in the dataset. The ATDCS also inputs human generated information, such as the name of the annotation for tracking information and the termination condition, in the model database (block 101 of FIG. 1).

Terminating conditions may be expressed in many different forms. For example, a terminating condition may be expressed as the number of positive dataset examples desired, the number of negative dataset examples desired, or both. Alternatively or additionally, the terminating condition may be expressed as a budget that is spendable on the crowdsourcing venue, and when this budget is met or exceeded, the ATDCS terminates its attempt to discover a model for that particular annotation. As another example, the terminating condition may be expressed as the number of iterations of the feedback loop before declaring that the loop is unable to build a model for that annotation based upon the given seed. Other terminating conditions can be incorporated as well.

In order to start the iterative process of formulating training data for building a predictive model (for a designated annotation), a seed word, multiple words, or phrase is needed that is a strong predictor of the designated annotation. A seed algorithm is then used to find positive examples of datasets that can be categorized with the designated annotation and negative examples of datasets that should not be categorized with the designated annotation. Many different seeding algorithms can be used for this purpose, including a breadth first search of an index of words contained in the corpus starting from an initial keyword/phrase (the seed), potentially picked by a user.

As another example, if the annotation is “politics,” the seed word that can be used as a strong predictor of whether or not to apply the annotation is the word “politics.” The seeding algorithm can then perform an initial search to find datasets with the word “politics” as a feature of the dataset. When the seeding algorithm reaches the number of positive and negative datasets it desires to find, it can simply terminate. In one embodiment, the default number of positive and negative dataset examples are 100 each and the algorithm looks for negative examples after the positive ones are found. Other embodiments may have other defaults and/or the number may be a selectable or tunable parameter.

Other techniques for determining an initial set of positive examples of a designated annotation and negative examples of a designated annotation may be used. For example, the ATDCS itself may run an algorithm on the entire corpus, such as a Latent Dirichlet Allocation, to initially designate annotations for the set of datasets. Alternatively, the ATDCS may run an indexed search on the datasets of a portion or all of the corpus, using for example a search engine like Lucene, to generate an index of words (a keyword graph that relates keywords to other keywords), and choose how far removed a word is from the desired seed using a “k-nearest neighbor like” approach before one considers the annotation to not be accurate. For example, the ATDCS can perform a breadth first search of the index to determine (as an example) all keywords immediately connected to a chosen seed keyword (connected by a single edge) are to be used to search for positive examples of the seed. In addition, the ATDCS can then determine (as an example) that all keywords separated by the seed keyword and its immediately connected keywords by at least one level of indirection are to be used to search for negative examples of the seed word. (Other degrees of separation may be used.) Although the results of whether the dataset should be annotated with the designated annotation may not be accurate, the feedback loop will cause these dataset assignments to self-correct by nature of the crowdsourced supplementation.

FIG. 3 is an example block diagram of a portion of a keyword graph that can be used by an automated tool for selecting training dataset examples. Graph 300 contains a portion of the index of words relating to the keyword “animal” as generated by a program such as Lucene. In graph 300, the seed word (simply as an example) is the keyword “animal” 311. The ATDCS first considers the words separated by one connector (an edge between two nodes) in a breadth first search of the index, including “horse,” “dog,” “cat,” “duck,” “salmon,” and “rat” (secondary nodes) to be words that can be generate positive examples. Once the ATDCS looks for these words in the datasets, the ATDCS may have to add additional words from the index, for example, if insufficient positive dataset examples are found from the first set of words. In this case, the ATDCS follows as many of these secondary nodes as needed to find additional edges (connections) that will generate positive examples. This means that if a dataset contains any of the positive example keywords, for seeding algorithm purposes, the dataset will initially be considered a positive example. In one example ATDCS, each dataset is only considered once. In graph 300, these secondary nodes (words) are shown in dotted pattern. Once sufficient positive data set examples are found, the ATDCS is tasked with using the index to automatically discover (find) negative dataset examples. In at least one example ATDCS, the system simply assigns the nodes (their corresponding words) that are another (an additional) edge away from the already “consumed” nodes and uses these corresponding words to find negative examples. That is, any dataset that contains any of these “negative” example keywords, will be considered for seeding purposes to be a negative example. In this example the nodes designated by crosshatching are considered to be far enough away from the topic “animal” to be negative examples.

Notice that these are mere assumptions used to create an initial ansatz model using a seeding algorithm—they may not be correct. For example, a dataset containing the phrase “animal abuse statistics” may be eventually be considered by the feedback loop to in fact be a dataset that should be annotated with the category “animal” even though the initial seeding algorithm did not find this so. Choosing the right distance (number of edges) from the topic keyword as discriminating between a positive and negative example may influence initially how precise the initial model created from the seed is; however, since the ATDCS iterates and refreshes the training datasets with positive examples that are human verified, this initial distance has less permanent effect than might otherwise be the case.

Specifically, the example seeding algorithm described (e.g., the breadth first algorithm) maximizes exposure to discriminating features for analysis. The positive examples are taken as those closest to the seed feature, negative examples start when the positive examples are complete. The feedback mechanism of the crowdsourcing naturally adjusts the starting points for where to look for positive and negative examples because the seed features are known when the ATDCS goes back to begin a subsequent iteration of the loop (block 102) AFTER crowdsourcing has been used to validate some positive training examples. In this case, the training data is biased to include the examples validated and the initial seed based examples fill in the remaining number of desired examples. (They are stored in the model database for future reference.) For example, if the first pass through crowdsourcing yielded 40 positive examples and 60 negative examples, the seeding algorithm performed by the ATDCS in the next round will only use 60 positive examples and 40 negative examples by default. So, with subsequent iterations, fewer seed based datasets are selected.

Once the initial positive and negative dataset examples are selected, then the ATDCS creates an “ansatz” predictive model (e.g. in block 103 of FIG. 1), using for example, SVMs (Support Vector Machines) or other types of machine learning models/tools. The ansatz model is created with the understanding that the results are dubious because of a strong possibility that the results may be wrong. For purposes of the iterative process described by FIG. 1, the ansatz model is presumed to have been built with accurate training data and is used (e.g. in block 104 of FIG. 1) to predict annotations on the remaining corpus (the datasets and their metadata) that has not been checked with crowdsourcing.

Of note, when creating a “model” for an annotation, strong predictive power can be realized by finding features (words, phrases, descriptors, and the like) that overlap. Features can be said to overlap when they co-occur when a particular topic is present. That is, if all datasets that can be annotated with the topic “animal” always also contained the feature “dog,” then co-occurrence of the words “dog” and “animal” would be highly predictive for classifying future datasets. It is also the case, however, that having too many predictive features makes prediction of classification more difficult. In this case it may be difficult to determine whether a dataset that contains many but not all of the overlapping features for topic “A” that are also many but not all of the overlapping features for topic “B” should be classified as an “A” or a “B.” Accordingly, it is important to have sufficient features for their discriminating power, yet not too many to cause too much overlap.

One way to solve this issue is to employ a principle component analysis to reduce features so that only the more important features are used as predictive features. Some machine learning techniques, as here, implement a principle component analysis implicitly as part of their implementation. A separate principle component analysis may also be incorporated. The end result—a good set of distinguishing features that allow strong discriminants for determining whether a model applies to a given dataset.

### Crowdsourcing

After the ansatz model has been applied to the corpus, the ATDCS determines a sample of datasets that are to be verified by crowdsourcing (e.g. in block 105 of FIG. 1) so as to increase the precision of training data that will be used to build the predictive model for the designated annotation (e.g. in block 108 of FIG. 1).

In order to send dataset (and corresponding metadata) samples to the crowdsourcing venue, a survey is created for the selected sample of datasets. There are many methods for formulating such surveys, some by automated methods as described with reference to FIG. 2. In one example, a template is used that includes a row of data from a dataset, its metadata, and a question that will elicit a “yes,” “no,” or “unsure” response. Thus, a survey such as survey 200 in FIG. 2 might ask in question 217 whether the data referred to by the row/metadata concerns “Politics and Government?” with user interface controls to indicate “yes,” “no,” “unsure,” or “not enough information.”

In addition to generating a survey for an annotation, the ATDCS determines which sample datasets (and metadata) to send for crowdsourcing validation. This sampling process may be performed in a variety of manners. Because the validation and collection of training data is an iterative process, it is possible to sample the datasets in a “biased” manner in order to elicit principal words (features) indicative of the designated annotation. One such sampling method, referred to as “reactive sampling,” is used herein although other sampling methods can be similarly incorporated.

Specifically, with reactive sampling, depending upon whether more positive or negative example datasets are needed, the ATDCS can choose datasets (as samples for crowdsourcing) that have been annotated using the ansatz predictive model with probabilities that indicate that they are “clearly in” (likely positive examples) or that indicate that they have a high co-occurrence of multiple words (features) and thus may be good discriminators once hand labeled by crowdsourcers to designate whether the annotation applies or does not apply (maybe positive examples).

More specifically, when using the predictive ansatz model (in block 104 of FIG. 1), its output can be defined in terms of a “probability” between zero and one. As in typical classifiers, if the outputted probability from the predictive model is above 50%, the answer is “yes” else (if the outputted probability is equal or below 50%) “no.” However, the probability for this threshold is tunable by, for example, a user of the ATCDS such as an ATCDS administrator. Accordingly, outputted probabilities around 50% are close to the threshold for a yes/no decision and may be incorrect. By sending some of these close cases to the crowdsourcing venue, additional discriminating examples may be discovered.

In one example embodiment, the sampling logic of the ATDCS (the “sampler”) reads from the model database and determines where it is missing information. For example, if the ATDCS (as may be evident from the terminating conditions) need more positive examples, the sampler selects datasets that whose probabilities outputted by the ansatz model are above the threshold for a yes/no decision (those well above 50%). In contrast, if the ATDCS determines that the model database has more positive examples than it needs (as may be evident from the terminating conditions) and not enough negative examples, the sampler looks closer at the datasets with probabilities outputted by the ansatz model that are closer to the threshold for a yes/no decision (for example, at the 50% probability level). By looking at the threshold, the sampler is finding datasets that have the highest co-occurrence of features and is depending upon the crowdsourcing to help differentiate these features.

Once the samples have been chosen, an automated survey can be generated (for the sampled datasets) and sent to the crowdsourcing venue, for example, using available APIs (application programming interfaces). The ATDCS will indicate how many recipients are required, with 7 being used as a default in one example ATDCS. There are multiple styles for the crowdsourcing survey question that can be chosen by the ATDCS user/administrator (as a configurable parameter) as described with reference to FIG. 2.

The number of survey recipients is also configurable. A default value of 7 survey recipients was chosen in one example ATDCS because it leads to a clear outcome when the outcome is obvious, and is somewhat robust to systematic bias, like crowdsource users just clicking answers at random. It is large enough to capture potential disagreements among those surveyed, but not so large as to expend resources unnecessarily. The example ATDCS uses standard binomial confidence intervals to decide which surveys have obvious yes/no answers. Binomial confidence intervals are discussed in C. J. Clopper and E. S. Pearson, “The Use of Confidence or Fiducial Limits Illustrated in the Case of the Binomial,” Biometrika 26:404-413, 1934, which is incorporated herein by reference.

The default crowdsourcing survey question (automatically generated using the template) is optimized to search for a binary result for a desired set of annotations. When the results of a surveyed dataset do not yield a clear binary result with a sufficient confidence interval, then this survey is sent back to the crowdsourcing venue to extend the number of recipients answering the survey. For example, the number may be increased from 7 to 17 to gain accuracy in the results for a surveyed dataset.

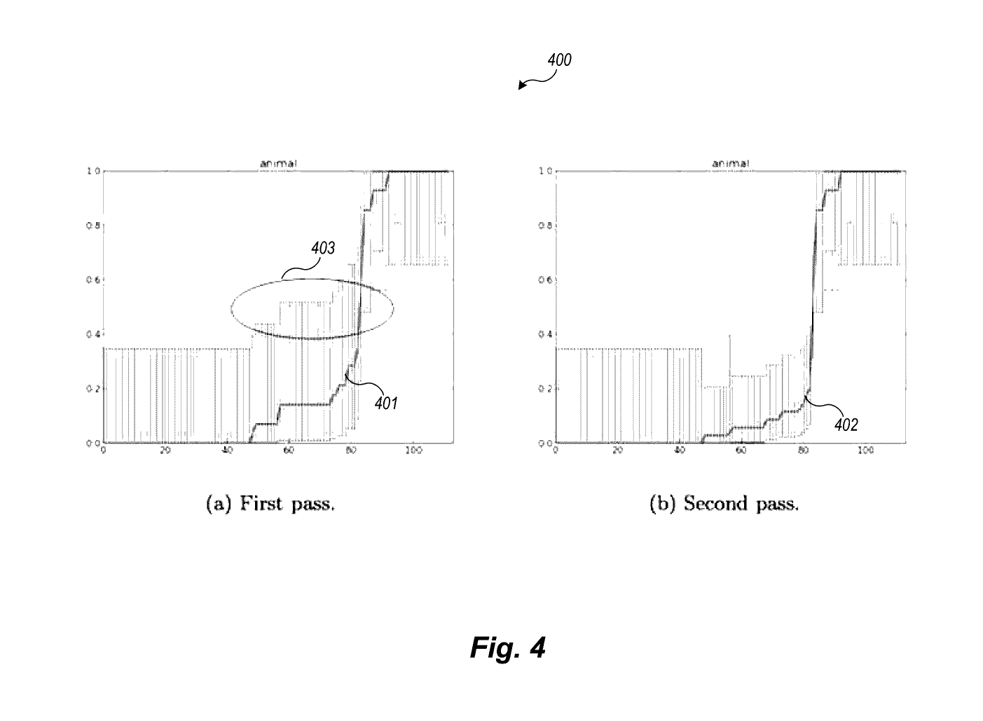

FIG. 4 is an example graph of the results of survey questions to answer whether the annotation “animal” is appropriate for the dataset(s) being surveyed. Each graph (in FIGS. 4a and 4b) shows 120 survey questions (for 120 datasets) created by the ATDCS to decide whether or not a surveyed dataset was about “animals.” Each point (on the solid blue line 401) along the x-axis corresponds to a dataset (survey question). Each point (on the solid blue line 401) along the y-axis shows the fraction of those surveyed that believe that the annotation “animal” is accurate for that question. Each band along the y-axis shows the 90% confidence interval for that answer. Thus, in FIG. 4(a), after the first pass to 7 recipients, over 50% of those surveyed indicated that slightly less than 40 of the datasets (survey questions) were indeed about “animals.” The positive results have been grouped on the right of each graph for convenience.

Thus, in the bulk of cases in this initial pass, the ATDCS can easily discern surveys where the answer is simply yes or no. The red oval circle 403 indicates a set of the survey questions (for datasets) where there is no clear yes/no, around the center of the plot where the bands are above or close to 0.5. In one example ATDCS, these survey questions are sent back to the crowdsourcing venue to extend the number of survey recipients for these surveys to elicit a stronger yes/no response. The result of sending these survey questions to a larger crowdsourcing audience is shown in FIG. 4(b), line 402, where there is a more clear division in the answers for survey questions (involving datasets 45-82). By increasing the number of surveys (in this case from 7 to 17 for demonstration), the ATDCS gains accuracy and reduces uncertainty.

These statistical methods can be incorporated into the ATDCS to minimize cost without a loss of accuracy by minimizing necessary exposure to crowdsourcing. Had a larger sample size been used at the beginning, the cost would be approximately doubled. In addition, most annotations apply to less than 1% of the total data—thus using a brute force approach likely would be wasteful as much of the information gained would not apply.

### Constructing the Predictive Model

As described with reference to FIG. 1, in block 108 once the terminating condition has been met indicating that the training set is complete, the ATDCS builds a predictive model for use in annotating the current datasets in the corpus (all of the datasets handled by the platform) with a particular annotation. The example ATDCS described a single annotation is classified by a model. Other ATDCS may have other implementations where more than one annotation is classified by a model.

In one example ATDCS, this is performed by building a Support Vector Model (SVM). The SVM is a machine learning program, that can be stored in a serialized data format for example, in a standard file, and loaded when it is to be executed. The training set data to be used as classifiers for the machine learning program has already been stored in the model dataset as a result of the previous training data generation. When a new dataset is to be annotated, the (SVM) model is loaded and executed using its training data as classifiers to determine whether or not to annotate the new dataset with a particular annotation.

### Model Scaling

In an example Scalable Annotation System described there is at least one predictive model generated for each annotation. In addition, there may be more than one model (with its training data—classifiers) per annotation. Some of these models may turn out to be better predictors than others. Thus, the system of models can be scaled (and trimmed) as the datasets and annotations grow.

Usually when forming a hierarchy of models, the best will be chosen according to a decision tree. Here, the SAS uses an array of models, each with a binary outcome, and applies the annotations to the datasets independently per model, where each model has its own features and its own test/train set for creation. A model manager receives in the data (a dataset) for annotation, feeds the input into each model separately, and returns back indicators to the models that returned a “yes” when asked the binary question, “is this dataset about X.” A list of annotations with p-values (probability values) is returned that determine how likely a particular annotation in the list is accurate.

Using this procedure, any model can be injected into the system and that model's performance will not affect the performance of any other annotation model because each is built and run separately. For example, if a new model is created about “flying monkeys,” its performance in production will not affect models already in use to create automated annotations for “politics,” “evil badgers,” and “food trucks” or even other models already in use to create automated annotations for “flying monkeys.”

As more data is gathered, the SAS can refine and version models independently so that any underlying API is not affected. In addition, issues regarding model boosting, multiple annotations, or customizing categories can be addressed separately while the models are in production.

### Scalable Annotation System Implementation

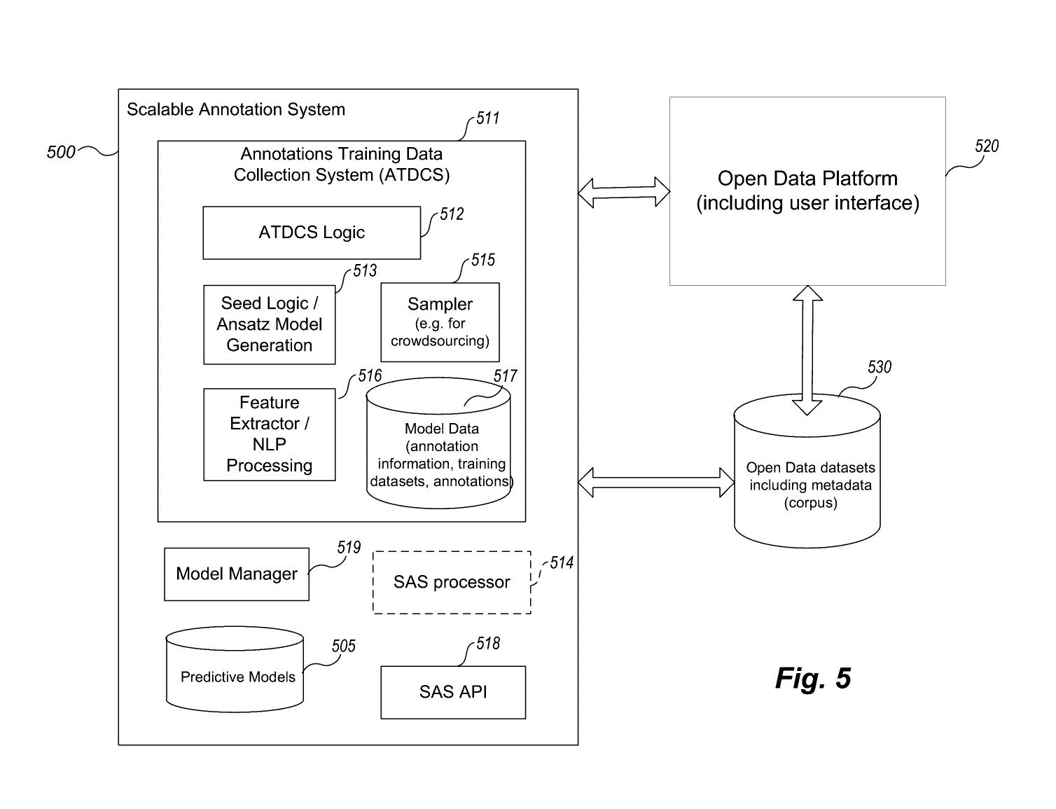

FIG. 5 is an example block diagram of components of an example Scalable Annotation Architecture. As discussed herein, in one example, the Scalable Annotation Architecture (“SAS”) comprises one or more functional components/modules that work together to annotate large amounts of data such as datasets 530 provided by an open data platform 520 such as SOCRATA.COM. For example, the SAS may comprise an Annotations Training Data Collection System 511 (“ATDCS”), which operates to create predictive models for annotations that can ultimately be applied to datasets to annotate a dataset automatically with tags having cross platform applicable definitions. In some embodiments, for example where the SAS operates as a specific machine, the SAS may comprise its own processor 514 (one or more), its own API 518, and a model manager 519 for access to algorithms, data, annotation models, amongst other things.

In the examples described here, the ATDCS 511 further comprises logic 512, which operates within the ATDCS 511 to generate predictive models for each desired annotation according to the block diagram described with reference to FIG. 1. This logic may be implemented in hardware, software, firmware or a combination and operates to cause the computing system it controls to be a specific machine targeted to automating the process of annotating datasets. The models, once generated, may be stored in a serialized form such as in data repository “Predictive Models” 505. The ATDCS 511 further comprises a seed logic/ansatz model generation component 513 (logic, module, instructions, etc.) which is structured to operate as described above to generate initial training set data for an annotation model and, upon each iteration, to supplement the training set with datasets found using a seed word. The ATDCS 511 further comprises a sampler 515 (component, logic, module, instructions, etc.) which is structured to sample annotated datasets to send them for further verification, such as by human labeling using crowdsourcing venues if appropriate. The ATDCS 511 further comprises a “model data” data repository 517 for storing training data for the predictive models, seeds, other data, and annotations as needed by the other components of the ATDCS 511. The ATDCS 511 may further incorporated a Feature Extractor/Natural Language Processing component 516 which is structured to analyze and extract features from datasets for aiding the other components of the ATDCS 511 to determine whether a feature(s) is present in a dataset. In some example SASes, component 516 may be externally provided to the system.

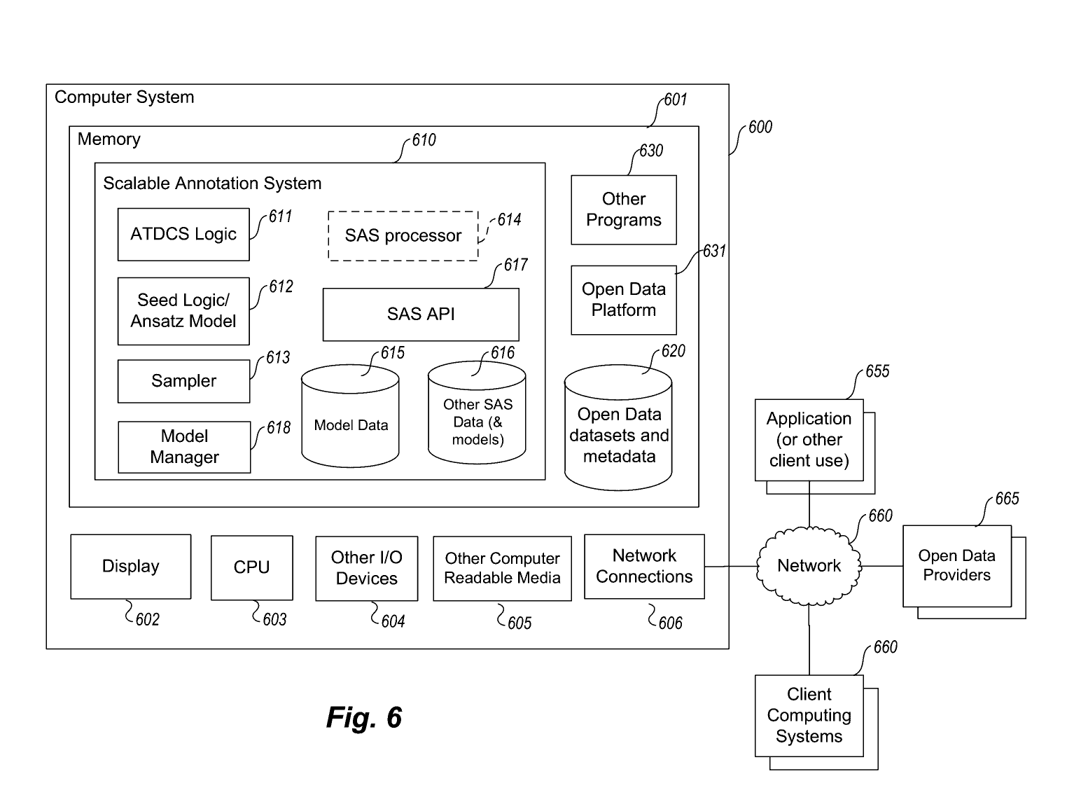

All and each components of the SAS may be implemented using one or more computing systems or environments as described with respect to FIG. 6.

Although the techniques of SAS and the ATDCS are applicable to open data, they are generally applicable to any type of data, especially large amounts accessible over a network. In addition, the concepts and techniques described are applicable to other annotation needs where the annotations are not known a priori. Essentially, the concepts and techniques described are applicable to annotating any large corpus of data.

Also, although certain terms are used primarily herein, other terms could be used interchangeably to yield equivalent embodiments and examples. In addition, terms may have alternate spellings which may or may not be explicitly mentioned, and all such variations of terms are intended to be included.

In addition, in the description contained herein, numerous specific details are set forth, such as data formats and code sequences, etc., in order to provide a thorough understanding of the described techniques. The embodiments described also can be practiced without some of the specific details described herein, or with other specific details, such as changes with respect to the ordering of the logic, different logic, etc. Thus, the scope of the techniques and/or functions described are not limited by the particular order, selection, or decomposition of aspects described with reference to any particular routine, module, component, and the like.

FIG. 6 is an example block diagram of an example computing system that may be used to practice embodiments of a SAS as described herein. Note that one or more general purpose virtual or physical computing systems suitably instructed (to become a specifically purposed machine) or a special purpose computing system may be used to implement an SAS. Further, the SAS may be implemented in software, hardware, firmware, or in some combination to achieve the capabilities described herein.

The computing system 600 may comprise one or more server and/or client computing systems and may span distributed locations. In addition, each block shown may represent one or more such blocks as appropriate to a specific embodiment or may be combined with other blocks. Moreover, the various blocks of the SAS 610 may physically reside on one or more machines, which use standard (e.g., TCP/IP) or proprietary interprocess communication mechanisms to communicate with each other.

In the embodiment shown, computer system 600 comprises a computer memory (“memory”) 601, a display 602, one or more Central Processing Units (“CPU”) 603, Input/Output devices 604 (e.g., keyboard, mouse, CRT or LCD display, etc.), other computer-readable media 605, and one or more network connections 606. The SAS 610 is shown residing in memory 601. In other embodiments, some portion of the contents, some of, or all of the components of the SAS 610 may be stored on and/or transmitted over the other computer-readable media 605. The components of the SAS 610 preferably execute on one or more CPUs 603 and manage the generation and use of predictive models for annotation, as described herein. Other code or programs 630, a platform 631 for manipulating open data, the open data itself 620, and potentially other data repositories also reside in the memory 601, and preferably execute on one or more CPUs 603. Some of these programs and/or data may be stored in memory of one or more computing systems communicatively attached such as by network 660. In some embodiments, for example where the SAS operates as a specific machine, the SAS may comprise its own processor 614 (one or more) and an API 617 for access to the various data and models. Of note, one or more of the components in FIG. 6 may not be present in any specific implementation. For example, some embodiments embedded in other software may not provide means for user input or display.

In a typical SAS environment, the SAS 610 includes the components described with reference to FIG. 5, including: ATDCS logic 611, one or more seed logic/ansatz model components 612, dataset sampler 613, model data 615, other SAS data 616 (including the generated predictive models), and model manager 618. In at least some embodiments, the model data 615 and/or SAS data 616 is provided external to the SAS and is available, potentially, over one or more networks 660. Other and/or different modules may be implemented. In addition, the SAS may interact via a network 660 with application or client code 655 that uses the annotated datasets, models, and/or SAS API 617, one or more client computing systems 660, and/or one or more third-party open data providers 665, such as the publishers of the open data used in open data repository 620. Also, of note, the open data repository 620 may be provided external to the SAS and to the open data platform as well, for example in a knowledge base accessible over one or more networks 660 (such as via a cloud based tool).

In an example embodiment, components/modules of the SAS 610 are implemented using standard programming techniques. For example, the SAS 610 may be implemented as a “native” executable running on the CPU 603, along with one or more static or dynamic libraries. In other embodiments, the SAS 610 may be implemented as instructions processed by a virtual machine. A range of programming languages known in the art may be employed for implementing such example embodiments, including representative implementations of various programming language paradigms, including but not limited to, object-oriented, functional, procedural, scripting, and declarative.

The embodiments described above may also use well-known or proprietary, synchronous or asynchronous client-server computing techniques. Also, the various components may be implemented using more monolithic programming techniques, for example, as an executable running on a single CPU computer system, or alternatively decomposed using a variety of structuring techniques known in the art, including but not limited to, multiprogramming, multithreading, client-server, or peer-to-peer, running on one or more computer systems each having one or more CPUs. Some embodiments may execute concurrently and asynchronously and communicate using message passing techniques. Equivalent synchronous embodiments are also supported.

In addition, programming interfaces to the data stored as part of the SAS 610 (e.g., in the data repositories 615 and 616) including the predictive models can be available by standard mechanisms such as through C, C++, C#, and Java APIs (e.g. API 617); libraries for accessing files, databases, or other data repositories; through scripting languages such as XML; or through Web servers, FTP servers, or other types of servers providing access to stored data. The data repositories 615 and 616 may be implemented as one or more database systems, file systems, or any other technique for storing such information, or any combination of the above, including implementations using distributed computing techniques.

Also the example SAS 610 may be implemented in a distributed environment comprising multiple, even heterogeneous, computer systems and networks. Different configurations and locations of programs and data are contemplated for use with techniques of described herein. In addition, the [server and/or client] may be physical or virtual computing systems and may reside on the same physical system. Also, one or more of the modules may themselves be distributed, pooled or otherwise grouped, such as for load balancing, reliability or security reasons. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, etc.) and the like. Other variations are possible. Also, other functionality could be provided by each component/module, or existing functionality could be distributed amongst the components/modules in different ways, yet still achieve the functions of an SAS.

Furthermore, in some embodiments, some or all of the components of the SAS 610 may be implemented or provided in other manners, such as at least partially in firmware and/or hardware, including, but not limited to one or more application-specific integrated circuits (ASICs), standard integrated circuits, controllers executing appropriate instructions, and including microcontrollers and/or embedded controllers, field-programmable gate arrays (FPGAs), complex programmable logic devices (CPLDs), and the like. Some or all of the system components and/or data structures may also be stored as contents (e.g., as executable or other machine-readable software instructions or structured data) on a computer-readable medium (e.g., a hard disk; memory; network; other computer-readable medium; or other portable media article to be read by an appropriate drive or via an appropriate connection, such as a DVD or flash memory device) to enable the computer-readable medium to execute or otherwise use or provide the contents to perform at least some of the described techniques. Some or all of the components and/or data structures may be stored on tangible, non-transitory storage mediums. Some or all of the system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

All of the above U.S. patents, U.S. patent application publications, U.S. patent applications, foreign patents, foreign patent applications and non-patent publications referred to in this specification and/or listed in the Application Data Sheet, including but not limited to U.S. Provisional Patent Application No. 62/189,656, entitled “SCALABLE ANNOTATION ARCHITECTURE,” filed Jul. 7, 2015, is incorporated herein by reference, in its entirety.

From the foregoing it will be appreciated that, although specific embodiments have been described herein for purposes of illustration, various modifications may be made without deviating from the spirit and scope of the invention. For example, the methods, systems, and techniques for performing data annotation discussed herein are applicable to other architectures other than a cloud-based architecture. Also, the methods, systems, and techniques discussed herein are applicable to differing application specific protocols, communication media (optical, wireless, cable, etc.) and devices (such as wireless handsets, electronic organizers, personal digital assistants, portable email machines, game machines, pagers, navigation devices such as GPS receivers, etc.).

1. An annotations training data collection system comprising:
collections system logic that is structured to control a computer processor to collect training data and generate a predictive model until a termination condition is reached, the termination condition indicating a desired number of positive training examples and a desired number of negative training examples;
seed logic that is structured to receive a designated annotation, determine a seed keyword that is indicative of the designated annotation, search for datasets of a corpus for datasets that positively contain the seed keyword until the desired number of positive training examples have been determined, search for datasets that do not contain the seed keyword until the desired number of negative training examples have been determined, and store the training examples in an annotation model repository;
an ansatz model builder that is structured to build a predictive model based upon the positive and negative training examples determined by the seed logic;
a sampler that is structured to determine, from the datasets remaining in the corpus that have not been indicated as training examples, a designated number of verification datasets; and
a labeling component that is structured to:
automatically create a survey based upon a template for determining whether the verification datasets are positive training examples or negative training examples;
send the created survey to a human labeling organization;
received the completed survey; and
stored the verified results as part of the positive and negative training examples in the annotation model repository;
wherein the collections system logic is structured to invoke the seed logic and ansatz model builder, sampler, and labeling component in order until the termination condition is reached, at which point the collections system logic produces a predicative model based upon the current training data stored in the annotation model repository.

2. The collection system of claim 1 wherein the labeling component is further structured to send the created survey to a crowdsourcing application.

3. The collection system of claim 1 wherein the labeling component is further structured to determine based upon the received completed survey that the results are indeterminate and send the survey back to the human labeling organization for further verification.

4. The collection system of claim 1 wherein the seed logic is structured to determine positive and negative training examples using a breadth first search of datasets for the seed keyword.

5. The collection system of claim 1 wherein the datasets are open data accessible from an open data platform.

6. The collection system of claim 1 wherein the datasets are open data accessible over a network.

7. The collection system of claim 1 wherein the created survey includes a first row and metadata for each dataset for which verification is sought.

8. The collection system of claim 1 wherein the predicative model based upon the current training data stored in the annotation model repository is independent from other produced predictive models so that it can be added and removed from a platform independently of other predictive models.

9. A computer facilitated method for annotating datasets with a designated annotation, comprising:
(a) receiving input of a termination condition that indicates a desired number of positive training examples and a desired number of negative training examples;
(b) determining a seed keyword that corresponds to the designated annotation and searching datasets of a corpus for the seed keyword, until the desired number of positive training examples and the desired number of negative training examples has been determined, wherein a dataset that contains the seed keyword is considered as a positive training example and wherein a dataset that does not contain the seed keyword is considered as a negative training example;
(c) under control of a computer system, storing the determined positive and negative training examples in an annotation training data repository;
(d) under control of the computer system, automatically building an ansatz model based upon the determined positive and negative training examples;
(e) under control of the computer system, automatically annotating the datasets based upon the ansatz model;
(f) under control of the computer system, automatically sampling the annotated datasets for a set of verification datasets;
(g) under control of the computer system, machine generating a survey to send for human labeling of the verification datasets, wherein the human labeling determines whether each verification dataset is a positive training example or a negative training example;
(h) sending the survey for human labeling and subsequently receiving the results of whether each verification dataset is a positive training example or a negative training example;
(i) integrating the resulting positive training examples and/or negative training examples from the verification datasets into the annotation training data repository;
(j) adjusting the desired number of positive training examples and the desired number of native training examples based upon the integrated training examples from the verification datasets; and
(k) repeating steps (a) through (k) until the termination condition is reached.

10. The method of claim 9, further comprising:
generating a predictive model for the designated annotation based upon the positive and negative training examples stored in the annotation training data repository.

11. The method of claim 10 wherein the generated predictive model for the designated annotation is a support vector machine.

12. The method of claim 9 wherein the human labeling is performed by a crowdsourcing application.

13. The method of claim 12 wherein the crowdsourcing application is accessed via an application programming interface.

14. The method of claim 9 wherein the verification datasets sent for human labeling result in cost expenditures from $50-$200 for a single annotation.

15. The method of claim 9 wherein a dataset is determined to contain the seed keyword if it contains a keyword that is within a k-nearest neighbor distance.

16. The method of claim 9 wherein the ansatz model is a support vector machine.

17. The method of claim 9 wherein the annotation data repository is a database.

18. A computer readable storage medium containing instructions for controlling a computer processor in a computing system to generate a predictive model for a designated annotation, by performing a method comprising:
(a) receiving input of a termination condition that indicates a desired number of positive training examples and a desired number of negative training examples;
(b) determining a seed keyword that corresponds to the designated annotation and searching datasets of a corpus for the seed keyword, until the desired number of positive training examples and the desired number of negative training examples has been determined, wherein a dataset that contains the seed keyword is considered as a positive training example and wherein a dataset that does not contain the seed keyword is considered as a negative training example;
(c) under control of a computer system, storing the determined positive and negative training examples in an annotation training data repository;
(d) under control of the computer system, building an ansatz model based upon the determined positive and negative training examples;
(e) under control of the computer system, annotating the datasets based upon the ansatz model;
(f) under control of the computer system, sampling the annotated datasets for a set of verification datasets;
(g) under control of the computer system, machine generating a survey to send for human labeling of the verification datasets, wherein the human labeling determines whether each verification dataset is a positive training example or a negative training example;
(h) sending the survey for human labeling and subsequently receiving the results of whether each verification dataset is a positive training example or a negative training example;
(i) integrating the resulting positive training examples and/or negative training examples from the verification datasets into the annotation training data repository;
(j) adjusting the desired number of positive training examples and the desired number of native training examples based upon the integrated training examples from the verification datasets;
(k) repeating steps (a) through (k) until the termination condition is reached; and
(l) generating a predictive model for the designated annotation based upon the positive and negative training examples stored in the annotation training data repository.

19. The computer readable storage medium of claim 18 wherein the generated predictive model for the designated annotation is a support vector machine.

20. The computer readable storage medium of claim 18 wherein the human labeling is performed by a crowdsourcing application.
